(19) United States
(12) Patent Application Publication
(10) Pub. No.: US 2007/0070913 A1
(43) Pub. Date: Mar. 29, 2007

(54) Data transmission method for wireless packet data based data transmission

(76) Inventor: Hans Kallio, Nokia (FI)

Correspondence Address: HARRINGTON & SMITH, PC, 4 RESEARCH DRIVE, SHELTON, CT, 06484-6212, US

(21) Appl. No.: 10/578,740

(22) PCT Filed: Dec. 15, 2004
(86) PCT No.: PCT/FI04/00765

§ 371 Date: May 9, 2006

(30) Foreign Application Priority Data
Dec. 18, 2003 (FI) 20031853

(51) Int. Cl. H04J 1/16; H04Q 7/24; H04J 3/24

(52) U.S. Cl. 370/252; 370/338; 370/474

(57) ABSTRACT

The invention relates to data transmission method which includes transmitting information over a wireless transmission link in the form of data packets. The method includes utilising a first protocol layer that adapts data packets according to a second, higher protocol layer to a form suitable for wireless data transmission, transmitting information used to identify the packets on said first protocol layer, and conditionally choosing a size for said information used to identify the packets between at least two alternatives.

### FIELD OF THE INVENTION

The invention relates to wireless packet data based data transmission.

### BACKGROUND OF THE INVENTION

Third generation (3G) mobile telephone network environments, such as Universal Mobile Telecommunications Systems (UMTS), offer users an opportunity for lossless packet data transmission, in which case a service called lossless Serving Radio Network Subsystem (SRSN) relocation is needed. In SRNS relocation the Radio Network Subsystem (RNS) serving terminal equipment is changed for another, for example, when the terminal equipment moves.

The lossless SRNS relocation service is provided by a Packet Data Convergence Layer (PDCP). In lossless SRNS relocation the PDCP layer takes care of that all the user's data packets are delivered to the destination in spite of the SRNS relocation. The functionality of the PDCP layer has been defined, among others, in the standard 3GPP TS 25.323 v 3.10.0 (2002-09) of the 3^{rd} Generation Partnership Project (3GDP). The PDCP layer operates on the Data Link layer (2^{nd} layer) of the Open System Interconnection (OSI) model and it has three functions:

1) Compression and decompression of the headers of Internet Protocol (IP) packets. Transport Control Protocol/Internet Protocol (TCP/IP) and Real-time Transport Protocol/Unstructured Data Protocol/Internet Protocol (RTP/UDP/IP) headers, among others, are examples of the headers to be compressed. Compression is needed, so that the limited radio resources available in the system can be utilised better.

2) Transmission of the user's data and adaptation of data packets according to higher protocol layers to a form suitable for wireless data transmission and vice versa. The PDCP layer receives Service Data Units (SDUs) from a Non Access Stratum (NAS) layer and transfers them to a Radio Link Control (RLC) layer and vice versa. The NAS layer is a functional layer between User Equipment (UE) and a Core Network (CN), which supports signalling and data transmission between the UE and the CN. The RLC layer is responsible for the functionality of the radio interface. The PDCP layer modifies the SDUs received from the NAS layer into PDCP Protocol Data Unit (PDU) packets of a form suitable for UMTS Terrestrial Radio Access Network (UTRAN) network elements. Thus the protocols of the NAS layer do not have to be directly compatible with the network elements.

3) Maintenance of PDCP sequence numbers (PDCP SeqNum) for those Radio Bearers (RB) that support lossless SRNS relocation.

In SRNS relocation a Radio Network Controller (RNC) serving the terminal equipment changes. In this context the “old” RNC is called the source RNC and the “new” RNC is called the target RNC. The PDCP maintains sequence numbers, which ensure that all data packets that the source RNC has not delivered onwards are delivered to the target RNC. The PDCP sequence numbers are sent in PDCP headers according to the definition laid down in section 5.4.1 of the 3GPP TS 25.323 v 3.4.0 (2001-03) standard. The PDCP sequence numbers are in the range 0-65535, so 16 bits (2 bytes) are needed for expressing one sequence number.

FIG. 1 shows two formats defined for PDCP PDU packets, wherein a PDCP header is attached to a PDCP SDU.

The fields of a PDCP-Data-PDU packet 10 include a 3 bit PDU Type field 12, which indicates the type of the PDCP packet, a 5 bit Packet Identifier (PID) field 13, which indicates how the headers of the SDU are compressed, and a data field 14, which comprises the actual data to be transmitted (the SDU). The PDCP-Data-PDU packet does not include a PDCP sequence number.

Correspondingly, a PDCP-SeqNum-PDU packet 11 comprises a PDU Type field 15, a PID field 16, and a data field 17 and moreover a 16 bit SeqNum field 18 and 18′ (a Most Significant Bit (MSB) and a Least Significant Bit (LSB) part of the field, respectively).

Even if the PDCP layer compresses headers of data units received from higher layers, the PDCP header itself is not compressed. On a general level the optimisation of the data transmission capacity of data transmission methods is a constantly relevant problem, and it is therefore necessary to look for different ways of optimising the amount of data transmitted in connection with the PDCP, too.

### SUMMARY OF THE INVENTION

One of the starting points of the present invention is an analysis of the PDCP header information. One of the basic ideas behind some embodiments of the invention is the observation that the sequence number field, the SN field, of the PDCP header can in some cases be reduced to 8 bits instead of the currently used 16 bit SN field, that is, the SN field can be shortened by 1 byte.

One of the basic ideas of the invention is to conditionally choose the size of the sequence number or other suitable information used to identify packets between at least two alternatives so that the size chosen is as small as possible.

According to a first aspect of the invention it comprises implementation of a data transmission method which comprises transmission of data over a wireless transmission link in the form of data packets and which method comprises:

utilising a first protocol layer, which adapts data packets according to a second, higher protocol layer to a form suitable for wireless data transmission;

transferring, on said first protocol layer, information used to identify the packets; and

conditionally choosing a size for said information used to identify the packets between at least two alternatives.

Said first protocol layer may be the PDCP layer, for example, and the second protocol layer may be a protocol of the network layer of the OSI model, such as some IP protocol, for example.

One embodiment of the invention comprises finding out the maximum number of data packets related to one data transmission connection and transmitted at the same time on said first protocol layer and performing said choice on the size on the basis of said maximum number.

In this context data packets related to one data transmission connection refer to data packets related to one PDCP entity and thus one Radio Bearer (RB), for example. In a UMTS environment said maximum number of data packets is supplied by a Radio Resource Control (RRC) layer. Of course these technical details can vary depending on the technology used.

According to a second and third aspect of the invention it comprises implementation of devices in accordance with claims 10 and 13.

A device according to the invention may be any device that can be in connection with some data transmission network over a wireless transmission link, or a suitable network element of a wireless data transmission network. Such a device may be, for example, a mobile station, a laptop computer, a handheld computer, a smart phone, a digital camera or a Radio Network Controller (RNC) element. The device in question may comprise in itself an air interface for sending and receiving data packets or the device may be functionally connected to an element providing an air interface. For example, an RNC element is functionally connected to a base station, which offers an air interface, whereas a mobile station, for example, comprises in itself the means that provide an air interface.

According to a fourth aspect of the invention it comprises implementation of a data transmission system in accordance with claim 15.

According to a fifth aspect of the invention it comprises implementation of a computer program in accordance with claim 16.

According to a sixth aspect of the invention it comprises implementation of an information structure in accordance with claim 18.

The dependent claims are related to preferred embodiments of the invention. The contents of dependent claims related to one aspect can be applied to the other aspects of the invention.

One advantage of one embodiment of the invention is, among other things, reduction of the amount of data transmitted, which means that more data can be transmitted over the air interface per unit of time.

### BRIEF DESCRIPTION OF THE FIGURES

In the following the invention is described in detail by means of examples with reference to figures attached, wherein

FIG. 1 shows PDCP packets according to the prior art;

FIG. 2 shows a system wherein the present invention can be applied;

FIG. 3 is a flow chart representing a method according to one embodiment of the invention;

FIG. 4 represents a part of a protocol stack which comprises a PDCP layer;

FIG. 5 is an example of two PDCP-SeqNum-PDU packets according to one embodiment of the invention;

FIG. 6 shows a simplified block diagram of a device according to one embodiment of the invention; and

FIG. 7 shows a simplified block diagram of a device according to another embodiment of the invention.

### DETAILED SPECIFICATION

For the sake of clarity the invention is described in the following by means of UMTS networks and PDCP sequence numbers especially without, however, limiting the invention to these technologies. The invention can be applied to any wireless data transmission technology wherein a first protocol layer is utilised that adapts data packets according to a second, higher protocol layer to a form suitable for wireless data transmission and wherein information used to identify the packets is transferred on said first protocol layer.

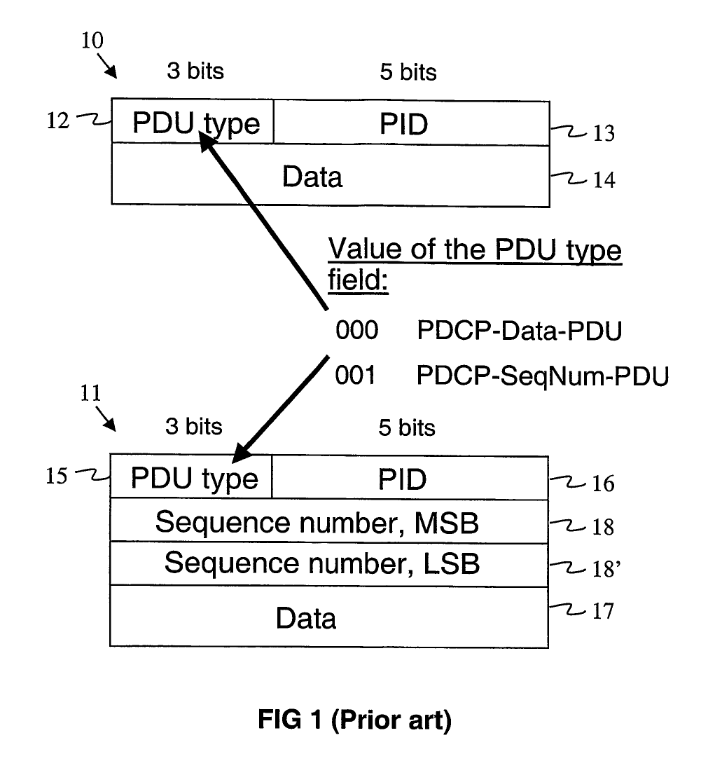

FIG. 1 has been described above in connection with the prior art.

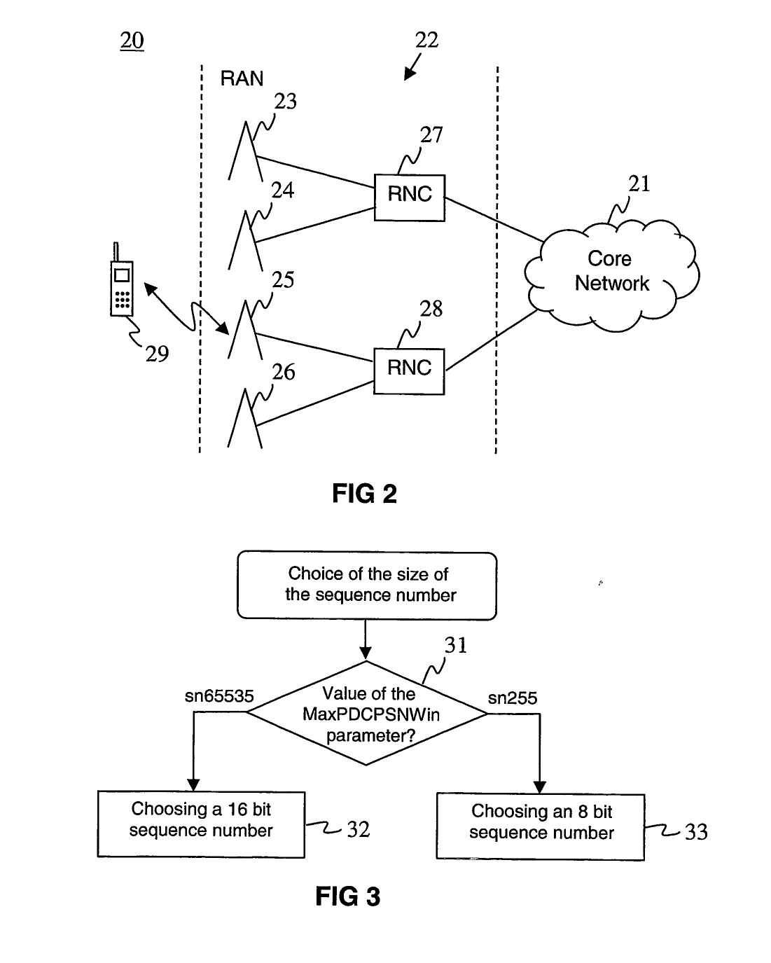

FIG. 2 shows a system 20 wherein the present invention can be applied. The system comprises a UMTS network, which in turn comprises a core network 21 and a Radio Access Network (RAN) 22, which provides a mobile station 29 with a wireless connection to the core network 21 and through it further to other services.

The radio access network 22 comprises two Radio Network Controllers (RNCs) 27 and 28 connected to the core network, which control use of radio resources. Both RNCs 27 and 28 are connected to two base stations 23-24 and 25-26, respectively. The base stations provide an air interface between terminal equipment and the radio access network. One RNC and the base stations connected to it form a Radio Network Subsystem (RNS). It must be noted that, for the sake of illustration, only part of the network elements of a UMTS network are shown. The practical implementation, of course, comprises elements not shown here.

The mobile station 29 in FIG. 2 is connected to the base station 25 and through it to the radio network controller 28. Let us suppose that the mobile station and the RAN support lossless SRNS relocation. Now if the mobile station changes over to using the base station 24, the serving radio network subsystem changes, and an SRNS relocation is performed. As this is a lossless SRNS relocation, PDCP sequence numbers are utilised to ensure the losslessness of data packets. In this connection optimisation of the size of the PDCP sequence number transmitted can be performed according to one embodiment of the invention. Examples of the practical implementation of the optimisation are presented in further detail below, in connection with FIGS. 3-5, among others.

It must be noted in this context that the system shown in FIG. 2 is just an example of a system where the invention can be used. Of course the invention can also be used in any other suitable environment.

FIG. 3 is a flow chart representing a method according to one embodiment of the invention, which comprises choosing the size of a PDCP sequence number conditionally.

Step 31 comprises investigation of the value of a MaxPDCPSNWin parameter. The MaxPDCPSNWin is one of the configuration parameters of a PDCP layer, which is defined on an RRC layer. The MaxPDCPSNWin parameter defines the maximum size of a PDCP sequence number window. This represents the maximum number of data packets that can be transmitted to a recipient on the level of the PDCP layer at the same time. Section 10.3.4.2 of the 3GPP TS 25.331 v 3.15.0 (2003-06) RRC standard defines two possible values for the MaxPDCPSNWin parameter, sn255 or sn65535.

If in step 31 of FIG. 3 it is found out that the value of the MaxPDCPSNWin parameter is sn65535, step32 comprises choosing a 16 bit sequence number to be used, that is, the sequence number can vary in the range 0-65535. This result corresponds to the current solution according to the prior art. If, however, in step 31 it is found out that the value of the MaxPDCPSNWin parameter is sn255, step 33 comprises choosing an only 8 bit sequence number to be used, that is, the sequence number can vary in the range 0-255. Thus the sequence number is limited as possible to the range 0-255, or the smallest possible size of the sequence number is chosen in order to optimise the amount of data to be transmitted.

In addition to the steps shown in FIG. 3, the number of data packets in a PDCP buffer can be taken into account in the present method when the size of the sequence number is chosen. If the number of data packets in the PDCP window (PDCP buffer) exceeds the value of the MaxPDCPSNWin parameter, when MaxPDCPSNWin=sn255, sequence numbers of 16 bits will then be sent, until the size of the PDCP window has been reduced to fewer than 256 packets.

However, it has been discovered by testing that the number of packets to be transmitted at the same time (the number of data packets in the window) often is less than 100 packets, so that sn255 would in many cases be a sufficiently large window size. In spite of this the solutions according to the prior art always use a (16 bit) PDCP sequence number varying in the range 0-65535.

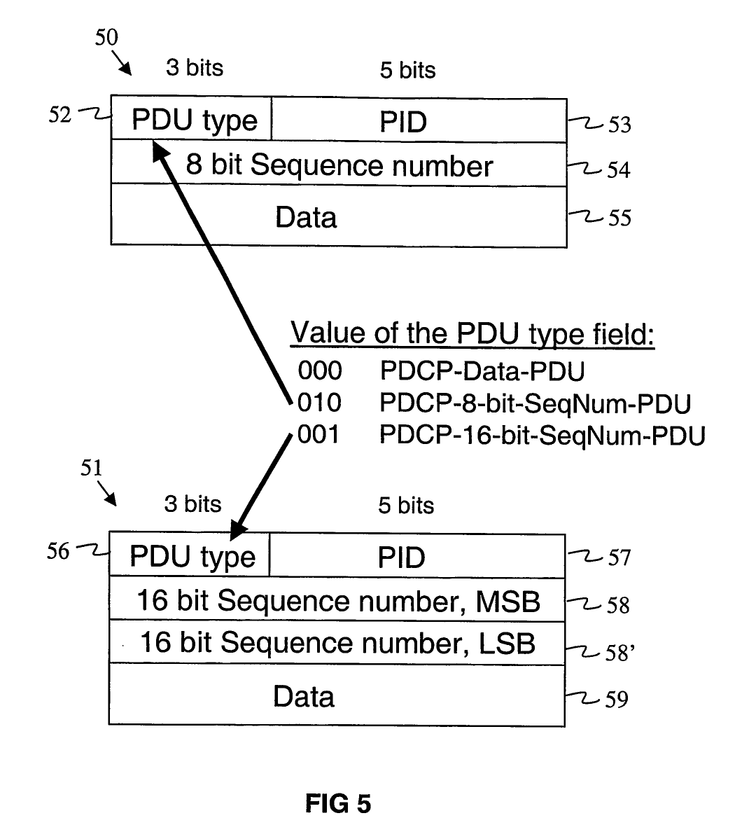

In order to transfer an 8 bit sequence number a new PDCP-SeqNum-PDU packet type is introduced in one embodiment of the invention. This packet type is described in further detail below in connection with FIG. 5.

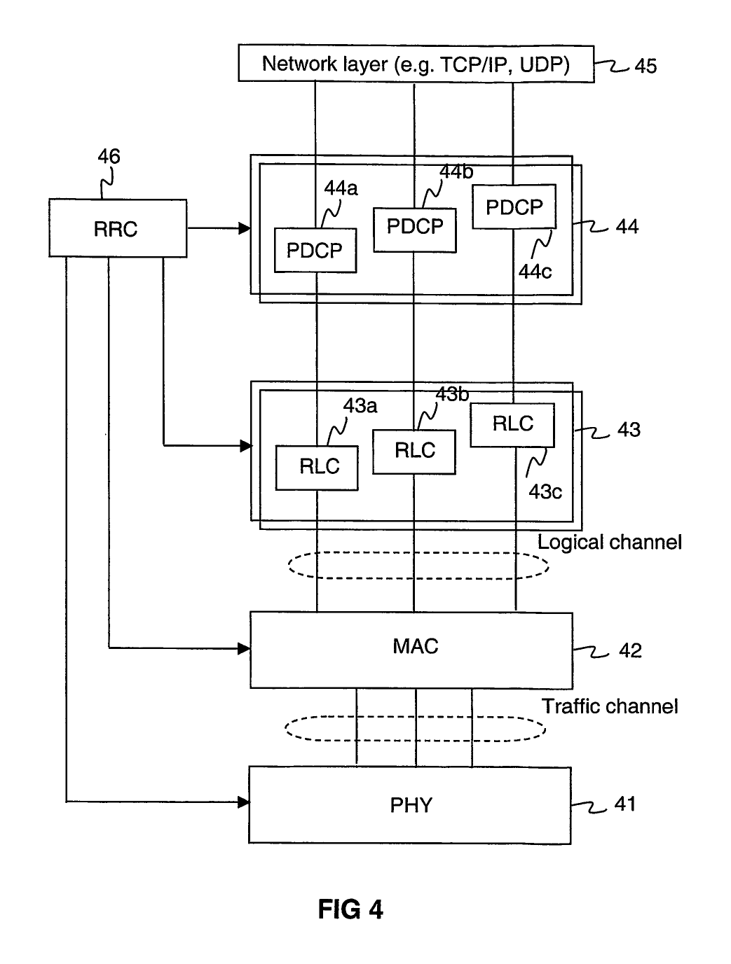

FIG. 4 represents part of a protocol stack that comprises a PDCP layer and in the implementation of which one embodiment of the present invention can be applied. The protocol stack in question can be implemented in wireless terminal equipment or a suitable network element of a wireless data transmission network, for example.

The protocol stack presented comprises a physical layer (PHY) 41, a Medium Access Control (MAC) layer 42, an RLC layer 43, a PDCP layer 44 and a network layer 45. The PDCP layer 44 comprises three PDCP entities 44a-44c, and the RLC layer 43 comprises three RLC entities 43a-43c. In addition, FIG. 4 shows an RRC layer 46, located in a control plane, which controls the operation of the physical layer 41, the MAC layer 42, the RLC layer 43, and the PDCP layer 44.

The network layer 45 corresponds functionally to the Non Access Stratum (NAS) layer. Among others IP protocols, such as TCP/IP and UDP protocols, operate on the level of the network layer. At the transmission end data packets according to network layer protocols are delivered to the PDCP layer to be supplied over the air interface to the recipient.

The PDCP layer formulates data packets according to the network layer protocols to a form suitable for the RLC layer and performs the compression of the headers of the data packets. In addition, the PDCP layer, if necessary, attaches PDCP sequence numbers to the data packets for example in connection with SRNS relocation or synchronisation of the PDCP sequence numbers. According to one embodiment of the invention the PDCP layer can be controlled to conditionally choose a size for the PDCP sequence numbers on the basis of the value of a MaxPDCPSNWin parameter received from the RRC layer 46. Each radio bearer corresponds to one PDCP entity 44a-44c, and each PDCP entity is in turn connected to one RLC entity 43a-43c. Each PDCP entity is configured separately by a CPDCP_config_req message supplied by the RRC layer, which defines, among other things, the MaxPDCPSNWin parameter specifically for each PDCP entity. The choice on the size of the sequence number takes place separately in each PDCP entity.

Among other things, the RLC layer 43 establishes (and releases) the radio link used to transmit the data packets. The RLC layer maps the data packets transmitted to it by the PDCP layer to one or more logical channels between the RLC layer and the MAC layer and transmits the data packets to the MAC layer 42. The MAC layer delivers the data packets to be transmitted through one or more traffic channels to the physical layer 41, which produces a physical transmission link and an interface to the radio path based on some radio access technology.

At the reception end the protocol stack described operates in a contrary fashion to the description given above.

FIG. 5 is an example of two PDCP-SeqNum-PDU packets according to one embodiment of the invention.

An 8 bit PDCP-SeqNum-PDU packet 50 comprises a 3 bit PDU Type field 52, which indicates the type of the PDU packet, a 5 bit Packet Identifier (PID) field, which indicates how the headers of the SDU have been compressed, and a data field, which comprises the actual data to be transmitted (the SDU). In addition to these fields, which are as such in accordance with the prior art, the 8 bit PDCP-SeqNum-PDU packet 50 comprises an 8 bit SeqNum field 54.

Correspondingly, a 16 bit PDCP-SeqNum-PDU packet 51 comprises a PDU Type field 56, a PID field 57 and a data field 59, and moreover a 16 bit SeqNum field 58 and 58′ (an MSB and an LSB part of the field, respectively). In principle the 16 bit PDCP-SeqNum-PDU packet is equivalent to the PDCP-SeqNum-PDU packet according to the prior art (for example, the PDCP-SeqNum-PDU packet 11 of FIG. 1), but the packet in question has now been renamed, because the two PDCP-SeqNum-PDU packets are used in parallel.

The 8 bit and the 16 bit PDCP-SeqNum-PDU packet are distinguished from each other by different values of the PDU Type field, for example so that the value 001 corresponds to the 16 bit PDCP-SeqNum-PDU packet and the value 010 corresponds to the 8 bit PDCP-SeqNum-PDU packet. The value 000 of the PDU Type field corresponds to the PDCP-Data-PDU packet according to the prior art.

The 8 bit PDCP-SeqNum-PDU packet is, of course, used for sending an 8 bit sequence number (or, one varying in the range 0-255) and the 16 bit PDCP-SeqNum-PDU packet is used for sending a 16 bit sequence number (or, one varying in the range 0-65535).

The invention can be implemented, for example, as a part of software performed on a suitable platform, which may be a processor in terminal equipment or server-type equipment. The invention can also be implemented as some other software and/or hardware application.

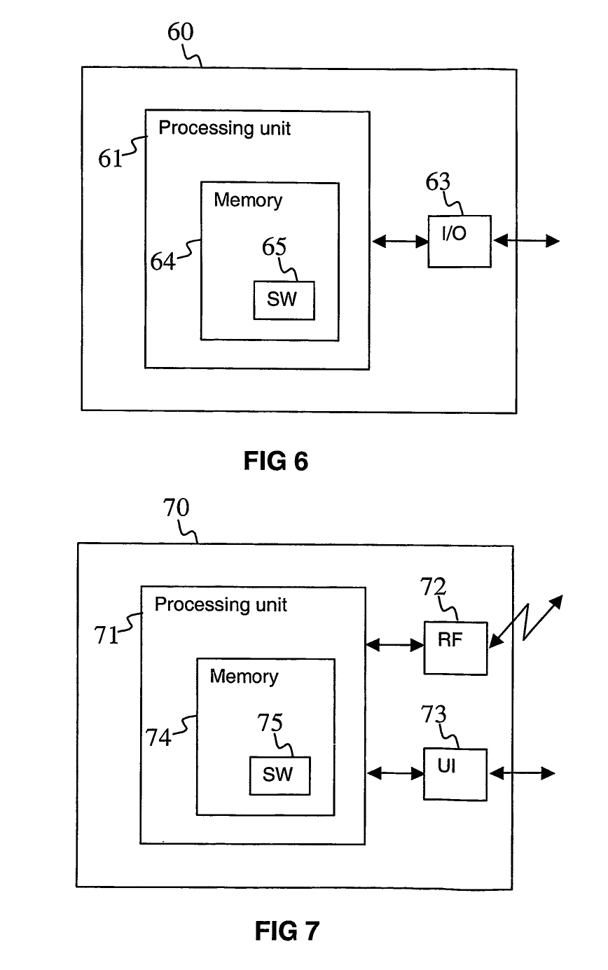

FIG. 6 shows a simplified block diagram of a device 60 according to one embodiment of the invention, which may be a network element of a wireless data transmission network, such as an RNC element, or some other device that does not include an air interface for sending and receiving data packets in itself but that is functionally connected to an element providing an air interface.

The device 60 comprises a processing unit 61 and a thereto connected I/O interface 63 through which the device communicates with other devices and through which information can be input to and output by the device.

The processing unit 61 comprises a processor (not shown in the figure), a memory 64 and computer software 65 to be performed by said processor. The processor controls the device to implement the functionality of a PDCP layer for data transmission according to the computer software 65. In connection with the use of PDCP sequence numbers the device is controlled according to the computer software 65 to conditionally choose a size for the sequence number between at least two alternatives, which may be 8 and 16 bits, for example.

FIG. 7 shows a simplified block diagram of a device 70 according to another embodiment of the invention, which may be any device that may be in connection with a data transmission network over a wireless transmission link, such as a mobile station, a laptop computer, a handheld computer, a smart phone or a digital camera.

The device 70 comprises a processing unit 71 and a thereto connected radio frequency (RF) section 72 and user interface (UI) 73. The radio frequency section 72 produces an air interface to implement data transmission over a wireless transmission link. The user interface may comprise a display and a keyboard, for example, and potentially some other control device (not shown in the figure) by means of which the device in question can be used. The invention can, however, be utilised in a device which does not have a user interface proper.

The processing unit 71 comprises a processor (not shown in the figure), a memory 74 and computer software 75 stored in the memory to be performed by said processor. According to the computer software 75 the processor controls the device to implement the functionality of a PDCP layer for data transmission. In connection with the use of PDCP sequence numbers the device is controlled according to the computer software 75 to conditionally choose a size for the sequence number between at least two alternatives, which may be 8 and 16 bits, for example.

The invention has above been described using the PDCP layer and PDCP sequence numbers of the UMTS technology as an example illustrating the invention, without, however, restricting the invention to this example. It is clear to those skilled in the art that the invention can be used with any other suitable network technologies. The possibilities of application and use of the invention are only restricted by the claims attached. Thus the different application alternatives defined by the claims, including equivalent applications, fall within the scope of the invention.

1. A data transmission method which comprises transmitting data over a wireless transmission link in the form of data packets and which method comprises
utilising a first protocol layer which adapts data packets according to a second, higher protocol layer to a form suitable for wireless data transmission;
transferring, on said first protocol layer, information used to identify the packets, and
conditionally choosing a size for said information used to identify the packets between at least two alternatives.

2. A data transmission method according to claim 1, which further comprises
finding out a maximum number of data packets related to one data transmission connection to be transmitted on said first protocol layer over said wireless transmission link at the same time; and
performing said choice of size on the basis of said maximum number.

3. A data transmission method according to claim 1, which further comprises
performing said choice in such a way that the size of the information is chosen to be as small as possible.

4. A data transmission method according to any claim 1, which further comprises
using a header structure related to the chosen size on said first protocol layer for transferring the information used to identify the packets.

5. A data transmission method according to claim 1 wherein said second protocol layer is a network layer protocol of the Open System Interconnection (OSI) model.

6. A data transmission method according to claim 1, wherein said first protocol layer is a Packet Data Convergence Protocol (PDCP) layer.

7. A data transmission method according to claim 1, wherein the information used to identify the packets is a sequence number.

8. A data transmission method according to claim 1, wherein said at least two sizes of the information used to identify the packets are 8 bits and 16 bits.

9. A data transmission method according to claim 7, which comprises choosing 8 bits for the size of the sequence number when the value of said sequence number varies in the range 0-255, and choosing 16 bits for the size of the sequence number when the value of said sequence number varies in the range 0-65535.

10. A device that comprises communication means for packet data based wireless data transmission, which communication means utilise a first protocol layer that adapts data packets according to a second, higher protocol layer to a form suitable for wireless data transmission, said communication means comprising
attachment means for attaching information used to identify the packets to the data packets to be transmitted on said first protocol layer, and
choosing means for conditionally choosing a size for said information used to identify the packets between at least two alternatives.

11. A device according to claim 9, wherein
a maximum number of data packets related to one data transmission connection to be transmitted on said first protocol layer over said wireless transmission link at the same time is found out; and
said choice of size is performed on the basis of said maximum number.

12. A device according to claim 9, wherein said device is a mobile station, a laptop computer, a handheld computer, a smart phone, a digital camera, or some network element of a wireless data transmission network or a Radio Network Controller (RNC) element.

13. A device that comprises communication means for packet data based wireless data transmission, which communication means utilise a first protocol layer that adapts data packets according to a second, higher protocol layer to a form suitable for wireless data transmission, said communication means comprising
reception means for receiving information used to identify the packets on said first protocol layer, configured to receive said information used to identify the packets in at least two alternative forms.

14. A device according to claim 13, wherein said device is a mobile station, a laptop computer, a handheld computer, a smart phone, a digital camera, or some network element of a wireless data transmission network or a Radio Network Controller (RNC) element.

15. A data transmission system that comprises at least one network element and at least one piece of terminal equipment, which network element and terminal equipment are connected to each other over a wireless transmission link and comprise
means for transmitting information over said wireless transmission link in the form of data packets;
means for utilising a first protocol layer, which first protocol layer adapts data packets according to a second, higher protocol layer to a form suitable for wireless data transmission;
means for transmitting information used to identify the packets on said first protocol layer, wherein at least either one of said network element and terminal equipment comprises
means for conditionally choosing a size for said information used to identify the packets between at least two alternatives.

16. A computer program to be performed in terminal equipment that comprises communication means for packet data based, wireless data transmission, which communication means utilise a first protocol layer that adapts data packets according to a second, higher protocol layer to a form suitable for wireless data transmission and attach information used to identify the packets to the data packets to be transmitted on said first protocol layer, said computer program comprising
a program code for conditionally choosing a size for said information used to identify the packets between at least two alternatives.

17. A computer program according to claim 16 stored on a carrier.

18. An information structure for transferring information used to identify packets over a wireless transmission link on a first protocol layer that adapts data packets according to a second, higher protocol layer to a form suitable for wireless data transmission, said information structure comprising a header field and a data field according to the first protocol layer for said data packet according to the second protocol layer, wherein
said header field comprises an 8 bit field for said information used to identify the packets.
